(19) United States
(12) Patent Application Publication
(10) Pub. No.: US 2026/0170467 A1
(43) Pub. Date: Jun. 18, 2026

(54) RECOVERY PREDICTION ANALYTICS FOR ENGINE WASH

(71) Applicant: GENERAL ELECTRIC COMPANY, Evendale, OH (US)

(72) Inventors: Mahalakshmi Shunmugam Balasubramaniam, Bengaluru (IN); Vivek Janu, Bengaluru (IN); Peter T. Gibbs, West Chester, OH (US); Balasubramaniam Ponnuchamy, Bengaluru (IN); Anil G. Shetty, Bengaluru (IN)

(21) Appl. No.: 19/019,869

(22) Filed: Jan. 14, 2025

Related U.S. Application Data
(60) Provisional application No. 63/733,459, filed on Dec. 13, 2024.

(51) Int. Cl. G06Q 10/20; B64F 5/30

(52) U.S. Cl. CPC G06Q 10/20; B64F 5/30

(57) ABSTRACT

A processor-implemented method for post-wash recovery prediction for aircraft components includes accessing wash event data associated with a component of an aircraft; averaging the data and determining outlying events; filtering the data to remove outlying events; performing feature engineering to determine a plurality of features; providing, as inputs to an analytic model, the plurality of features and the filtered data; predicting, by the analytic model, a post-wash recovery; and providing a washing recommendation based on the post-wash recovery to selectively cause the component to be washed.

### CROSS-REFERENCE TO RELATED APPLICATIONS

This application claims the benefit of U.S. Provisional Patent Application Ser. No. 63/733,459, filed Dec. 13, 2024, the entire contents of which is incorporated by reference herein.

### TECHNICAL FIELD

The present disclosure relates to performance recovery prediction for aircraft components. Particularly, the present disclosure relates to a system and a method for recovery prediction analytics for engine wash.

### BACKGROUND

Washing an aircraft's engine maintains performance and efficiency. Over time, dirt, dust, salt, and other contaminants can build up on engine components, which can lead to reduced airflow, increased drag, and higher fuel consumption. Regular washing helps remove these deposits, restoring the engine's optimal operating conditions and extending its lifespan. Additionally, a clean engine runs cooler and experiences less wear, which reduces maintenance costs and the likelihood of in-flight issues. Overall, engine washing is a preventive measure that supports performance and cost-effectiveness.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 illustrates a system for post-wash recovery prediction for aircraft components, according to an exemplary aspect;

FIG. 2 is a block diagram of a controller of the system of FIG. 1, in accordance with one aspect;

FIG. 3 is a block diagram of post-wash recovery prediction model in accordance with one aspect;

FIG. 4 is a graph illustrating engine gas temperature margin (EGTM) in accordance with one aspect;

FIG. 5 is an illustration of an engine of an aircraft illustrating atmospheric particle deposits in accordance with one aspect;

FIG. 6 is an image illustrating an aft stage compressor airfoil of an engine before a wash in accordance with one aspect;

FIG. 7 is an image illustrating the aft stage compressor airfoil of an engine after a water wash in accordance with one aspect; and

FIG. 8 is an image illustrating an aft stage compressor airfoil of an engine after a foam wash in accordance with one aspect.

### DETAILED DESCRIPTION

Although this disclosure will be described in terms of specific aspects, it will be readily apparent to those skilled in this art that various modifications, rearrangements, and substitutions may be made without departing from the spirit of this disclosure.

For the purpose of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the features illustrated herein, and any additional applications of the principles of this disclosure, as illustrated herein, which would occur to one skilled in the relevant art and having possession of this disclosure, are to be considered within the scope of this disclosure.

One system that may be used with the exemplary aspects is an engine tracking database system (ETDS). This system serves as the official record of time, cycles, configuration, and maintenance history of a given engine. It is provided to a customer who then maintains the currency of the ETDS through periodic updates of records. This system would feed data of configuration, time, and cycles on individual components to the main analytics core system.

One indicator that may be used with the exemplary aspects is the engine serial number (ESN). Each engine has a unique serial number that may be used to personalize individual assets and index their configuration and usage history records. The operational and/or environmental factors described above may be computed on an ESN basis. Other engine identifiers may also be used without departing from the scope of the present disclosure.

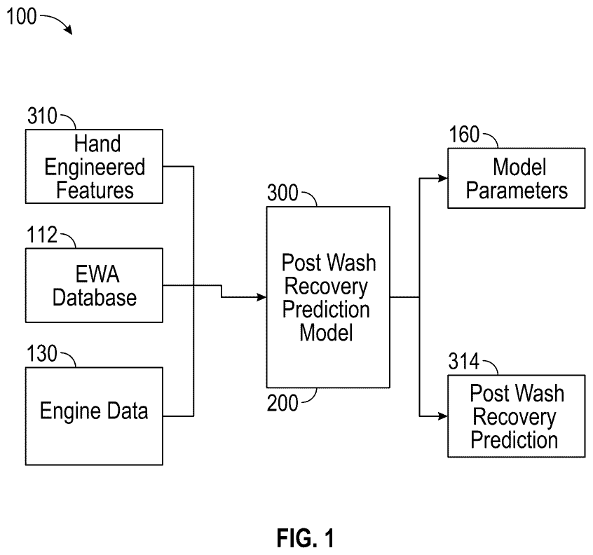

FIG. 1 illustrates an exemplary system 100 for recovery prediction analytics for component wash, according to an aspect. With increased fleet and utilization, the need to predict engine recovery after a wash and/or whether an engine wash is useful for better fleet planning. The system 100 generally includes a controller 200 configured to execute a prediction model 300. The prediction model 300 is configured to provide information predictive of a component's recovery after a wash and/or the selection of a component where washing is useful. For example, and not by limitation, the component may be an engine, such as an aircraft jet engine.

The aircraft component, e.g., the engine, may need cleaning of material deposited on a high-pressure compressor (HPC) flow path hardware. Deposited material may include, for example, dust, sand, hydrocarbon pollutants, salt-laden air (e.g., from coastal airports), and/or de-icing fluid (e.g., from runways and/or taxiways). There are at least two types of wash cleaning: water wash and foam wash. The foam wash provides the benefit of using chemistry to remove sand and dust contamination that is, for example, common to the Middle East.

Washing provides the benefits of HPC efficiency improvement, EGT (engine exhaust gas temperature) margin recovery, deterioration trending parameter estimating health of engine relative to certified max temperature level, using on-wing measured EGT at takeoff, fuel flow recovery, reduced carbon emissions, performance retention (cycles), reduced gas-path temperatures, reduced metal temperatures, mitigation of mid-life hot section distress, and improved time on wing.

The system 100 provides the benefits of providing a more accurate and precise forecast at the engine and customer level, higher modeling fidelity and flexibility than manual calculation, as well as providing insights for engineering such as enabling the evaluation of the strength of the impact of various variables.

The prediction model 300 may receive as input data, including, for example, raw time series flight-by-flight data, RD (e.g., remote diagnostics) data from individual flights, and/or data in model form. The system 100 can use data in model form to enable the incorporation of effects of various factors (Xs) on the flight-by-flight deterioration (e.g., engine deterioration). This enables modeling the interaction between various Xs (e.g., engine gas temperature (EGT), wash events, and/or hours of operation) and the ability to define new Xs from existing snapshot data. The system 100 is configured to fetch and ingest a wide variety of input data. For example, the input data may include fleet data and single-engine data; the latter may include single-engine performance data and single-engine configuration data. Once ingested, the single-engine data and the fleet data may be analyzed utilizing application-specific instructions located in controller 200. The system 100 is configured to provide prognostic analytic information associated with a single engine. This information may be output by the system 100 as recommendations to, for example, a graphic user interface and/or a controller (e.g., in the form of an electronic signal and/or machine translatable file) for operating, for instance, a valve that enables water or foam to be dispensed (e.g., sprayed) on the engine or an engine component for washing the engine or engine component. Such recommendations can include, for example, data and/or instructions (e.g., in the form of an algorithm) on how (e.g., type of wash such as foam and/or water) and/or when to wash (e.g., timing, frequency, duration, etc.) such engines or engine components.

In one aspect, the flight-by-flight data may include statistical parameters pertaining to a fleet of engines like the single-engine, whose single-engine data is provided to the individual component system 100. The fleet data may include performance data and configuration data pertaining to a plurality of engines. Performance data herein, for the single-engine or for the fleet of engines, may include, without limitation, cycle data, hours of operation, and operating temperature. Furthermore, configuration data, without limitation, may include any other configuration parameters associated with an engine. The time series flight-by-flight data may further include engine-specific data from the fleet, engine time on wing data, component scrap rate data, engine deterioration data, engine build configuration, utilization history.

System 100 provides an analytical method for selecting engines that are in a condition where washing is useful. Engine washing boosts engine efficiency by improving the engine exhaust gas temperature (EGT) margin, and other internal engine temperatures, which ultimately extends the interval between shop visits. Currently, when engines are recommended for foam wash trials, the selection process involves manually analyzing current EGT margins, previous shop visits, and past performance and wash history. This manual engine selection process is time-consuming and limited to only a few performance variables for decision-making.

The system 100 provides the benefit of leveraging historical and current engine wash data, along with hand-engineered features such as the rate of performance deterioration between wash events during the takeoff, climb, cruise, descent, and/or landing phases of an engine cycle which are different stages of an aircraft's flight, particularly in relation to the operation and performance of its engines. The takeoff phase is when the aircraft begins its flight, moving from the ground into the air. It starts from engine spool-up at the beginning of the runway to the moment the aircraft leaves the ground (lifts off). The climb phase begins once the aircraft has taken off and continues as it ascends to cruising altitude. This phase typically lasts from the end of takeoff to when the aircraft reaches a designated altitude for cruising (usually above 10,000 feet). The cruise phase occurs after the climb, once the aircraft has reached its cruising altitude. The cruise phase is the longest phase of flight, during which the aircraft maintains level flight at a constant altitude. The descent and landing phases are the final stages of a flight, where the aircraft reduces altitude and prepares for a safe touch-down. These phases involve careful control of the aircraft's speed, descent rate, and engine power to ensure a smooth and safe arrival at the destination. The descent phase begins once the aircraft has reached cruising altitude and starts to reduce altitude toward the airport. It typically starts anywhere from 100 to 200 nautical miles from the destination airport, depending on air traffic control (ATC) instructions and flight planning. The landing phase begins when the aircraft reaches the final approach for landing and ends when it has safely touched down on the runway and slowed to a complete stop. This phase involves complex coordination of the aircraft's speed, altitude, and landing gear deployment, as well as careful use of the engines. These phases correspond to various stages of flight where the engines are working under different loads and conditions. These factors serve as inputs to an analytic model that estimates improvements in EGT margin, fuel flow, and compressor efficiency if a wash is performed on the engine. Such estimates may be combined with predefined criteria, such as current EGT margin, engine cycles since the last shop visit, and engine cycles since the last wash, to make informed decisions.

The system 100 generally includes a prediction model 300. The output of the analytics model may be used for maintenance decisions, including foam wash or water wash planning and wash type sequence. In aspects, the system 100 may also be used to make optimal wash interval recommendations (e.g., wash is the maintenance decision enabled) for an ESN/customer using the performance recovery prediction model. In aspects, the system 100 may provide a web-based application that can be used to develop custom wash schedules for various engine lines and components.

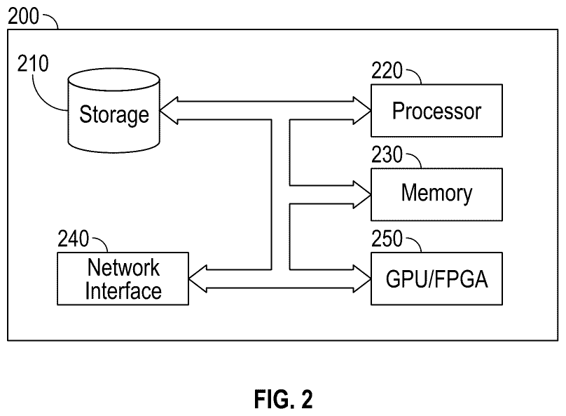

Referring now to FIG. 2, exemplary components in the controller 200 in accordance with aspects of the present disclosure include, for example, a database 210, one or more processors 220, at least one memory 230, and a network interface 240. In aspects, the controller 200 may include a graphical processing unit (GPU) 250, which may be used for processing machine learning network models.

Database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In various aspects, data may be stored on controller 200, including, for example, user preferences, historical data, and/or other data. The data can be stored in database 210 and sent via the system bus to processor 220.

As will be described in more detail later herein, processor 220 executes various processes based on instructions that can be stored in the memory 230 and utilizing the data from database 210. With reference also to FIG. 1, a request from a user device, such as a mobile device or a client computer, can be communicated to the server through the server's network interface 240. The illustration of FIG. 2 is exemplary, and persons skilled in the art will be understood by other components that may exist in a controller 200. Such other components are not illustrated in FIG. 2 for clarity of illustration.

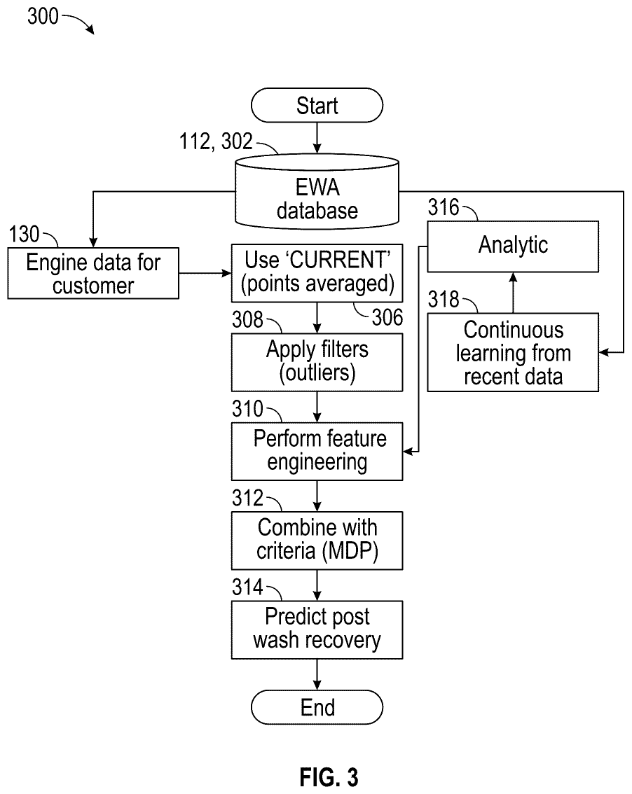

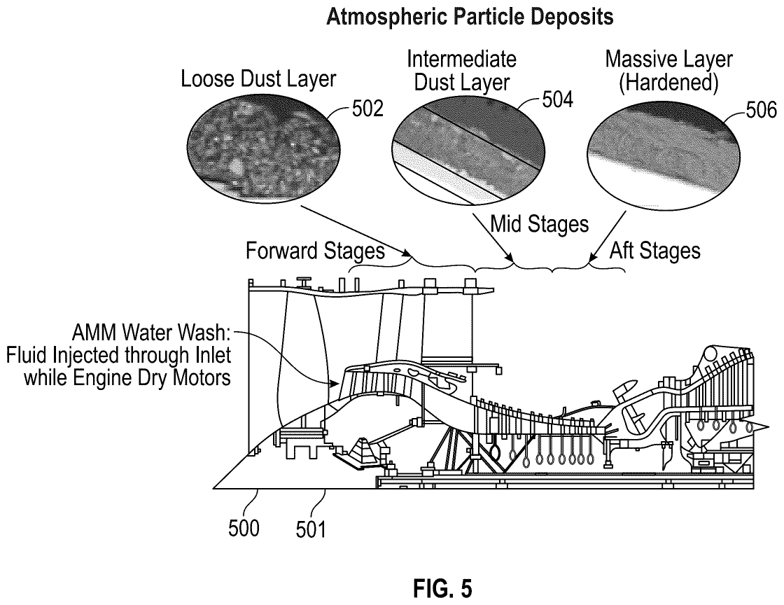

Referring to FIG. 1-3 and 5, a prediction model 300 for post-wash recovery prediction for one or more components (e.g., engine 500) of an aircraft 501 (FIG. 5) is shown. The controller 200 (FIG. 2) causes the system 100 (FIG. 1) to access time series flight-by-flight data associated with a component of an aircraft. The flight-by-flight data may include performance data. For example, flight-by-flight data 152 may include engine-specific data from the fleet, wash event related data (e.g., frequency of wash, date/time of last wash or prior washes, type of wash, duration of wash, timing of wash, etc.), engine time on wing data, and/or engine deterioration data. In another example, the flight-by-flight data 152 may include flight-by-flight time at temperature and/or other environmental factors. The EGT temperature is generally measured by one or more thermocouples mounted in the exhaust stream.

At operation 302, the system 100 causes controller 200 to access wash event data event associated with a component of an aircraft (e.g., an engine). The accessed data may come from a database 112 or may be historical engine data 130 for a particular user (e.g., a customer). The accessed wash event data may include, for example, engine exhaust gas temperature, compressor efficiency, fuel flow, rate of deterioration of the component after a wash, shop visit time, and/or engine wash frequency. In aspects, in cases where there is no wash history (e.g., when wash history is absent), the system 100 may use data from a similar model component. In aspects, the system 100 may also access data on an engine at the point in time just prior to a potential wash event and provide a potential decision to actually do a wash event (or not) depending on what the recovery analytic predicts.

At operation 318, the system 100 causes controller 200 to perform continuous learning to adjust an analytic model based on recent data. In aspects, the system 100 may update coefficients of the analytic model based on continuous learning. For example, results from the analytics model may be used to adjust coefficients of the model, for example, weights in the machine learning model to improve the results. For example, in the case where the analytic model is a stochastic gradient descent (SGD), weights may be updated iteratively. In aspects, the controller 200 may monitor the model's performance to ensure the model remains accurate over time and addresses any signs of drift. The controller 200 may use regularization techniques to prevent overfitting as new patterns emerge in the data. The continuous learning may adjust one or more of the model parameters 160 (FIG. 1.), for example, in the case of a machine learning model, the parameters may include various weights.

At operation 314, the system 100 causes controller 200 to predict engine exhaust gas temperature recovery, using the analytic model 316, based on the data accessed in operation 302. Although engine exhaust gas temperature recovery is used as an example, system 100 may predict any internal engine temperature (or other performance features). The analytic model may include a regression model and/or a machine learning model. In aspects, the analytic model may be trained on historical wash records. For example, the analytic model may predict the engine gas temperature recovery by analyzing the relationship between input features (independent variables) and a continuous target variable (dependent variable) based on patterns learned during training. The model calculates a mathematical function, for example, in the form of a weighted sum of the inputs that best fits the observed data. When given new input data, the model applies this function to predict an output value. In aspects, the model may include linear regression and/or more complex models. The more complex models may include, for example, polynomial or neural network regressions that use non-linear relationships to improve accuracy.

At operation 306, the system 100 causes controller 200 to average the user engine data 130 and determine any outlying events (e.g., events that deviate more than plus or minus 15% to 20% from the average in a given set of data). In aspects, the data accessed from database 112 may be averaged, and outlying events may be determined. The controller 200 may determine whether these outlying events are errors or anomalies that may deviate far from the average set of data (e.g., plus or minus 25% from the average in the given set of data). For instance, if the outlying events are determined by the controller 200 to be errors (e.g., data entry mistakes, sensor errors, etc.), the controller 200 may choose to correct or remove them. For anomalous outlying events, the controller 200 may perform trimming, which removes extreme values, or Winsorizing, which caps the values at a certain threshold (e.g., plus or minus 15% to 20% from the average in the given data set) to reduce the effect of outlying events while keeping all data points in the dataset, making it a useful technique for minimizing the influence of extreme values without completely removing the values.

At operation 308 the system 100 causes controller 200 to filter the data to remove outlying events. In aspects, the data accessed from database 112 may be filtered to remove outlying events.

At operation 310 the system 100 causes controller 200 to perform feature engineering to determine a plurality of features. Feature engineering is the process of creating, modifying, or selecting features (variables) in a dataset to improve the performance of an analytic model. Feature engineering involves transforming raw data into informative attributes that can help the model make better predictions, such as by scaling, normalizing, or combining features. For example, the plurality of features may include: a rate of deterioration of a performance variable during climb, cruise, take off, decent and/or landing phases, a wash frequency, and/or a wash type sequence. A performance variable may include, for example, EGTM. In aspects, the system may indicate and/or differentiate between which segment of time over which deterioration may be assessed (e.g., since the last wash). Rate of deterioration may include a rate of deterioration since original initialization to the moment just before a wash, or the rate of deterioration of all prior post-wash performance levels (e.g., ignoring inter-wash deterioration). The accessed data may be collected from different flight phases of operation.

At operation 312, the system 100 may cause controller 200 to combine the features with a set of criteria. The criteria may include a Markov decision process (MDP). MDP is a framework for modeling decision-making in environments where outcomes are partly random and partly under the control of a decision-maker. MDPs are commonly used in reinforcement learning to represent problems where an agent takes actions to maximize cumulative rewards over time, given the current state and a transition model to predict future states. The criteria may include a correlation threshold, a variance threshold, dominance relevance criteria, and/or statistical significance criteria. For example, the controller 200 may select features that have a high correlation with the target variable and low multicollinearity with other features. For example, the controller 200 may select only features with variance above a certain threshold, which helps exclude uninformative, low-variance features. The controller 200 may include features that are known to be important based on domain knowledge, which can improve interpretability and effectiveness. The controller 200 may select features with p-values below a certain level (e.g., 0.05) in regression models, indicating a statistically significant relationship with the target.

The system 100 causes controller 200 to provide as inputs to the analytic model the plurality of features. At operation 314 the system 100 causes controller 200 to provide, by the analytic model, a post-wash recovery prediction based on the inputs. In aspects, the controller 200 may cause the system 100 to determine a wash frequency and wash type sequence based on the provided post-wash recovery prediction. In aspects, the controller 200 may cause the system 100 to determine whether to perform a water wash or a foam wash, or no wash at all based on the provided post-wash recovery prediction. In aspects, the controller 200 may cause the automatic wash of the engine based on the

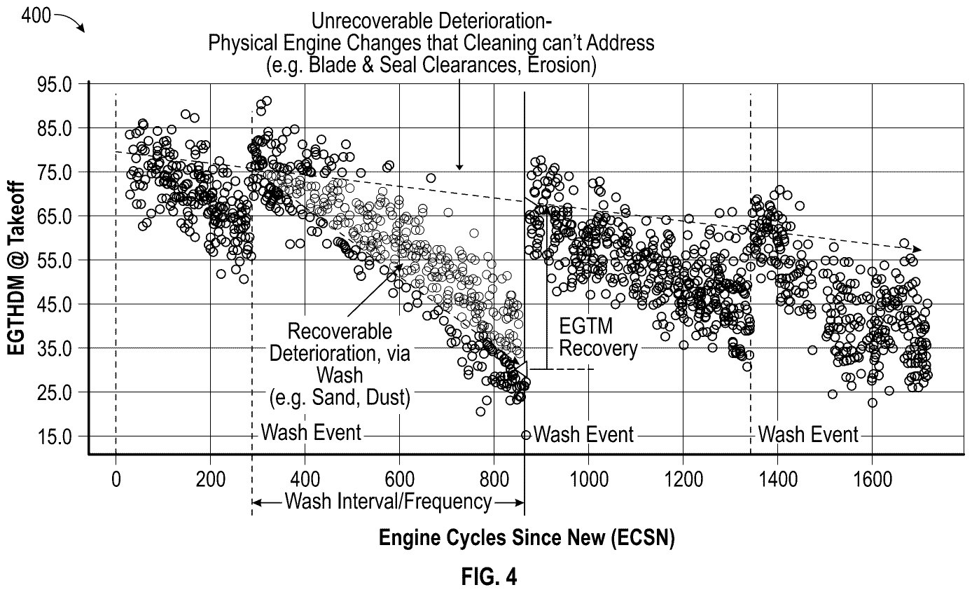

Referring to FIG. 4, a graph illustrating engine exhaust gas temperature margin (EGTM) at takeoff is shown. The graph illustrates how the EGTM is reduced between wash events and how the margin is improved after a wash event. For example, the graph illustrates how deterioration may fall into two categories: recoverable EGTM deterioration and unrecoverable EGTM deterioration. Recoverable EGTM deterioration, for example, EGTM deterioration due to sand, dust, and other accumulations, may be recovered by washing the aircraft component. Whereas unrecoverable EGTM deterioration, which may be caused by physical engine changes, may be improved by a wash of one or more components of an engine despite the physical engine changes.

FIG. 5 is an illustration of an engine of an aircraft illustrating atmospheric particle deposits in an engine 500 (e.g., a component of an aircraft). Atmospheric particle deposits may form, for example, a loose dust layer 502 (forward stage of the engine inlet), an intermediate dust layer 504 (mid stage), and a hardened layer 506 (aft stage). A water wash typically injects fluid through an inlet of the engine 500.

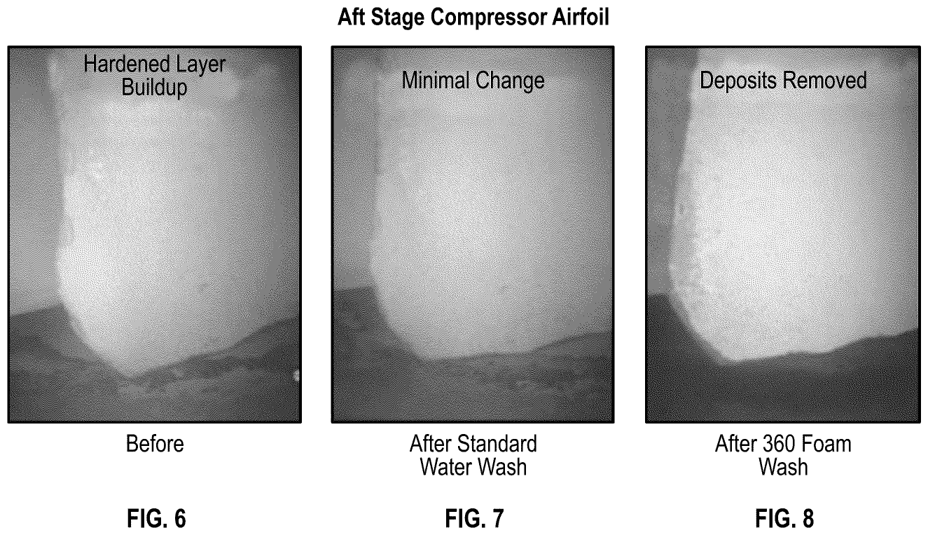

FIG. 6 is an image illustrating an aft stage compressor airfoil of an engine before a wash event. FIG. 7 is an image illustrating the aft stage compressor airfoil of an engine after a water wash event. FIG. 8 is an image illustrating an aft stage compressor airfoil of an engine after a foam wash event. The foam wash provides the benefit of using chemistry to remove sand and dust contamination that is, for example, common to the Middle East.

Advantageously, the system 100 provides the benefits of providing a more accurate and precise determination of predicting, by the analytic model, a post-wash recovery and recommends when and how to wash an engine (or one or more components thereof) based on this prediction. Washing provides the benefits of HPC efficiency improvement, EGT (engine exhaust gas temperature) margin recovery, deterioration trending parameter estimating health of engine relative to certified max temperature level, using on-wing measured EGT at takeoff, fuel flow recovery, reduced carbon emissions, performance retention (cycles), reduced gas-path temperatures, reduced metal temperatures, mitigation of mid-life hot section distress, and improved time on wing.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” or “in other aspects” may each refer to one or more of the same or different aspects in accordance with this disclosure.

Further aspects of the present disclosure are provided by the subject matter of the following clauses.

A system for post-wash recovery prediction for aircraft components includes: a processor; and a non-transitory memory including instructions which, when executed by the processor, cause the system at least to perform: accessing wash event data associated with a component of an aircraft; averaging the data and determining outlying events; filtering the data to remove outlying events; providing as inputs to an analytic model a plurality of features and the filtered data; predicting, by the analytic model, a post-wash recovery; and providing a washing recommendation based on the post-wash recovery to selectively cause the component to be washed.

The system according to the preceding clause, wherein the accessed data wash event data includes at least one of engine exhaust gas temperature, compressor efficiency, fuel flow, rate of deterioration of the component after a wash, shop visit time, or engine wash frequency.

The system according to any preceding clause, wherein the instructions which, when executed by the processor, further cause the system at least to perform: determining a wash frequency and wash type sequence based on the provided post-wash recovery.

The system according to any preceding clause, wherein the analytic model is trained on historical wash records.

The system according to any preceding clause, wherein the instructions which, when executed by the processor, further cause the system at least to perform: when wash history is absent, using second data from a different component as the data wash event data associated with the component of the aircraft.

The system according to any preceding clause, wherein the plurality of features includes at least one of a rate of deterioration of a performance variable during climb, cruise, takeoff, decent, and/or landing phases, a wash frequency, or a wash frequency and wash type sequence.

The system according to any preceding clause, wherein the analytic model includes at least one of a regression model or a machine learning model.

The system according to any preceding clause, wherein the instructions which, when executed by the processor, further cause the system at least to perform: updating coefficients of the analytic model based on continuous learning.

The system according to any preceding clause, wherein the instructions which, when executed by the processor, further cause the system at least to perform: performing at least one of a water wash or a foam wash or no wash based on the provided post-wash recovery.

The system according to any preceding clause, wherein the component is an engine.

A processor-implemented method for post-wash recovery prediction for aircraft components includes: accessing wash event data associated with a component of an aircraft; averaging the data and determining outlying events; filtering the data to remove outlying events; performing feature engineering to determine a plurality of features; providing as inputs to an analytic model the plurality of features and the filtered data; predicting, by the analytic model, a post-wash recovery; and providing a washing recommendation based on the post-wash recovery to selectively cause the component to be washed.

The processor-implemented method according to the preceding clause, wherein the accessed data wash event data includes at least one of engine gas temperature, compressor efficiency, fuel flow, rate of deterioration of the component after a wash, shop visit time, or engine wash frequency.

The processor-implemented method according to the preceding clause, further comprising determining a wash frequency and wash type sequence based on the provided post-wash recovery.

The processor-implemented method according to any preceding clause, wherein the analytic model is trained on historical wash records.

The processor-implemented method according to any preceding clause, further comprising in a case where there is no wash history, data from a similar model component is used as the wash event data associated with the component of the aircraft.

The processor-implemented method according to any preceding clause, wherein the plurality of features includes at least one of a rate of deterioration of a performance variable during climb, cruise, takeoff, decent, and/or landing phases, a wash frequency, or a wash type sequence.

The processor-implemented method according to any preceding clause, wherein the analytic model includes at least one of a regression model or a machine learning model.

The processor-implemented method according to any preceding clause, further comprising updating coefficients of the analytic model based on continuous learning.

The processor-implemented method according to any preceding clause, further comprising performing at least one of a water wash or a foam wash or no wash based on the provided post-wash recovery.

A processor-implemented method for post-wash recovery prediction for aircraft components, the method includes: accessing wash event data associated with a component of an aircraft; averaging the data and determining outlying events; filtering the data to remove outlying events; performing feature engineering to determine a plurality of features; providing as inputs to an analytic model the plurality of features and the filtered data; predicting, by the analytic model, a post-wash recovery; and providing a washing recommendation based on the post-wash recovery to selectively cause the component to be washed.

It should be understood that the description herein is only illustrative of this disclosure. Various alternatives and modifications can be devised by those skilled in the art without departing from the disclosure. Accordingly, this disclosure is intended to embrace all such alternatives, modifications, and variances. The aspects described are presented only to demonstrate certain examples of the disclosure. Other elements, steps, methods, and techniques that are insubstantially different from those described above and/or in the appended claims are also intended to be within the scope of the disclosure.

What is claimed is:

1. A system for post-wash recovery prediction for aircraft components, the system comprising:
a processor; and
a non-transitory memory including instructions which, when executed by the processor, cause the system at least to perform:
accessing wash event data associated with a component of an aircraft;
averaging the data and determining outlying events;
filtering the data to remove outlying events;
performing feature engineering to determine a plurality of features;
providing, as inputs to an analytic model, the plurality of features and the filtered data;
predicting, by the analytic model, a post-wash recovery; and
providing a washing recommendation based on the post-wash recovery to selectively cause the component to be washed.

2. The system of claim 1, wherein the accessed data wash event data includes at least one of engine exhaust gas temperature, compressor efficiency, fuel flow, rate of deterioration of the component after a wash, shop visit time, or engine wash frequency.

3. The system of claim 1, wherein the instructions, when executed by the processor, further cause the system at least to perform:
determining a wash frequency and wash type based on the predicted post-wash recovery; and
causing a wash based on the determined wash frequency and wash type.

4. The system of claim 1, wherein the analytic model is trained on historical wash records.

5. The system of claim 1, wherein the instructions, when executed by the processor, further cause the system at least to perform:
when wash history is absent, using second data from a different component as the data wash event data associated with the component of the aircraft.

6. The system of claim 1, wherein the plurality of features includes at least one of a rate of deterioration of a performance variable during climb, cruise, takeoff, decent, and/or landing phases, a wash frequency, or a wash type sequence.

7. The system of claim 1, wherein the analytic model includes at least one of a regression model or a machine learning model.

8. The system of claim 1, wherein the instructions, when executed by the processor, further cause the system at least to perform:
updating coefficients of the analytic model based on continuous learning.

9. The system of claim 1, wherein the instructions, when executed by the processor, further cause the system at least to perform:
performing at least one of a water wash or a foam wash based on the predicted post-wash recovery.

10. The system of claim 1, wherein the component is an engine.

11. A processor-implemented method for post-wash recovery prediction for aircraft components, the processor-implemented method comprising:
accessing wash event data associated with a component of an aircraft;
averaging the data and determining outlying events;
filtering the data to remove outlying events;
performing feature engineering to determine a plurality of features;
providing as inputs to an analytic model the plurality of features and the filtered data;
predicting, by the analytic model, a post-wash recovery; and
providing a washing recommendation based on the post-wash recovery to selectively cause the component to be washed.

12. The processor-implemented method of claim 11, wherein the accessed data wash event data includes at least one of engine gas temperature, compressor efficiency, fuel flow, rate of deterioration of the component after a wash, shop visit time, engine wash frequency, hours since last wash as another example of data, or cycles since last wash, wherein the accessed data is collected from different flight phases of operation.

13. The processor-implemented method of claim 11, further comprising:
determining a wash frequency and wash type sequence based on the predicted post-wash recovery; and
causing a wash based on the determined wash frequency and wash type.

14. The processor-implemented method of claim 11, wherein the analytic model is trained on historical wash records.

15. The processor-implemented method of claim 11, further comprising:
in a case where there is no wash history, using data from a similar model component as the wash event data associated with the component of the aircraft.

16. The processor-implemented method of claim 11, wherein the plurality of features includes at least one of a rate of deterioration of a performance variable during climb, cruise, takeoff, decent, and/or landing phases, a wash frequency, or a wash type sequence.

17. The processor-implemented method of claim 11, wherein the analytic model includes at least one of a regression model or a machine learning model.

18. The processor-implemented method of claim 11, further comprising:
updating coefficients of the analytic model based on continuous learning.

19. The processor-implemented method of claim 11, further comprising:
performing at least one of a water wash or a foam wash based on the predicted post-wash recovery.

20. A processor-implemented method for post-wash recovery prediction for aircraft components, the processor-implemented method comprising:
accessing wash event data associated with a component of an aircraft;
averaging the data and determining outlying events;
filtering the data to remove outlying events;
performing feature engineering to determine a plurality of features;
providing as inputs to an analytic model a plurality of features and the filtered data;
predicting, by the analytic model, a post-wash recovery; and
providing a washing recommendation based on the post-wash recovery to selectively cause the component to be washed.
